(19) United States
(12) Patent Application Publication
(10) Pub. No.: US 2003/0023462 A1
(43) Pub. Date: Jan. 30, 2003

(54) Method and system for insuring the future value of real property

(76) Inventor: Anthony Jason Heilizer, Washington, DC (US)

Correspondence Address: Anthony Heilizer, 2117 Observatory Pl., NW, Washington, DC, 20007, US

(21) Appl. No.: 10/192,163

(22) Filed: Jul. 11, 2002

Related U.S. Application Data
(60) Provisional application No. 60/304,482, filed on Jul. 12, 2001.

(51) Int. Cl. G06F 17/60

(52) U.S. Cl. 705/4

(57) ABSTRACT

A method is disclosed for insuring the future value of real property (defined as real estate property) and a means to do so which creates a quantitative risk profile and premium value that allows insurance companies the opportunity to price the cost and risk offering this type of insurance product entails. The insurance is offered once the potential policyholder completes an application that contains information about both the property and the potential policyholder. The insurance provider than computes a premium cost associated with that policy. The policyholder then selects the length and type of coverage they want. The insurance then goes into effect and the insured future value is then paid to the policy holder if the insurance is activated as long as the policyholder has kept current on the payment of the premium.

The inventor claims the benefit of the filing date of his provisional patent application, No. 60/304,482 dated Jul. 12, 2001.

### FIELD OF INVENTION

This invention relates to the field of real property insurance. In particular, the invention concerns a system and method for property owners to insure the future value of their real estate.

### BACKGROUND OF THE INVENTION

Today there are many consumer-oriented insurance products for the property owner.

The most popular forms of insurance include:

Private Mortgage Insurance: Most lenders desire a borrower to make a down payment of at least 20% of the value of the home. If the homebuyer does not have sufficient funds for a 20% down payment, a lender may require the borrower to purchase Private Mortgage Insurance (PMI). PMI allows homebuyers to put down less than 20% of the total value of the property since the mortgage is insured on behalf of the lender. If the property owner defaults on the mortgage the PMI company pays in full, or in part, the outstanding mortgage on behalf of the borrower, thereby insuring the lender that at least a portion of the mortgage will be paid even if the borrower defaults on the loan.

Property Insurance: Most property owners purchase insurance that protects the value of the property from damage caused by accidents or acts of nature. At a minimum, this insurance typically covers fire, wind and flooding damage. If this type of policy is in place, the property owner can receive an amount up to the replacement value of the house. Lenders often require the borrower to purchase property insurance.

Mortgage Life/Disability Insurance: This insurance covers the full payment of the mortgage if the borrower dies or becomes disabled. This insurance is used by property owners as a form of life or disability insurance.

Mortgage Payment Assistance Insurance: This insurance assists property owners with their mortgage payments during the period they are unemployed.

While these products are popular with property owners and mortgage companies, none of these products directly protect or insure the re-sale value of the property owner's biggest asset; their house.

### SUMMARY OF THE INVENTION

Today millions of Americans own their home. For most of them, their house represents the biggest financial investment they will ever make. However, each property owner independently takes the risk that the value of their home will appreciate. If there is a global, national or regional recession or if their neighborhood becomes less desirable the individual property owner absorbs that loss of equity which may have a significant effect on their net worth. The inventor believes there is a need for a product, which for the purpose of this description is labeled “ValueGuard”, that limits the risk of devaluation of a person's home.

The ValueGuard product insures the property owner that his property will increase in value at a minimum rate. A property owner can purchase a ValueGuard policy that insures the value of the home will increase at a predetermined rate. This rate can be tied to a form of index (LIBOR, Inflation Rate, Treasury Rates, etc.) or it can be a fixed rate (for example, 0.5%, 2%, 3.5% etc.). The property owner can also decide the length of the coverage for his policy. The coverage can be for a set period of time, run in perpetuity or run until the property owner sells the house. Based on the type of coverage the property owner desires, the ValueGuard Provider charges the property owner a periodic (monthly, semi-annual, annual) fee for the coverage.

If the policy is still active when the property owner desires to sell the house, the property owner is guaranteed that the ValueGuard Provider will purchase the home at the predetermined price. However, the property owner may sell the house for a higher price by himself and therefore not use the ValueGuard protection. However, if the value of the home has lagged the insured value, then the property owner can require the ValueGuard Provider to purchase the house at the predetermined value, less any transaction costs.

### BRIEF DESCRIPTION OF DRAWINGS

FIG. 1 is a block diagram of the entire system of the invention.

FIG. 2 is a flowchart of the property owner under the invention.

FIG. 3 is a flowchart of ValueGuard Provider under the invention.

FIG. 4 is a flowchart of activation of the coverage under the invention.

FIG. 5 is a block diagram of Provider's database operations.

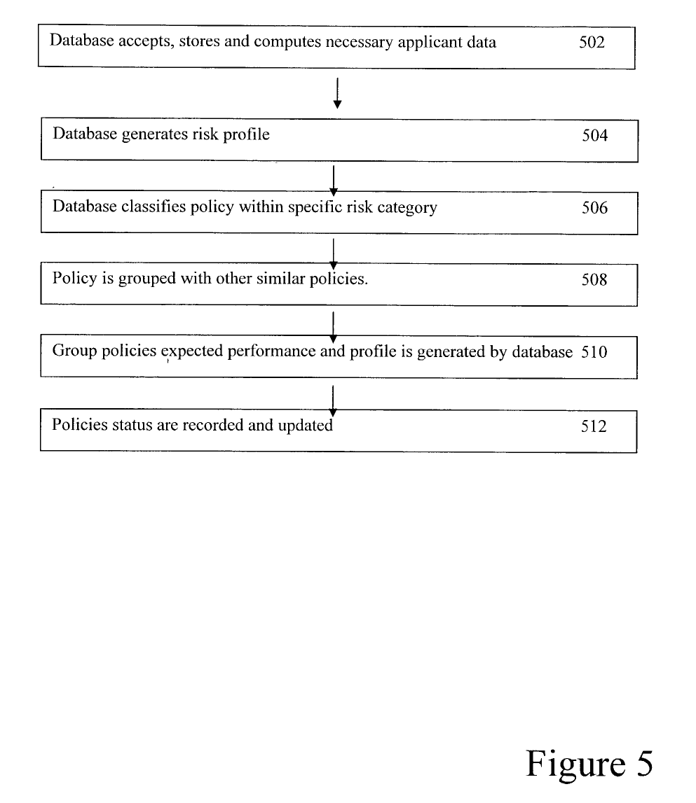

### DETAILED DESCRIPTION OF PREFERRED EMBODIMENT OF THE INVENTION

Today property owners have only a few insurance options to protect their home's value. Typically, a property owner purchases property insurance to protect his house from potential damage caused by a severe weather or other accidents. However, most property owners personally assume all of the risk associated with the potential depreciation of their home's value.

The present invention permits a home (or property) owner to purchase insurance that protects him from the change in the economy that can adversely affect the value of his house. The ValueGuard insurance allows a property owner to purchase a policy that will guarantee the property owner a minimum sale price based on the specifics of the policy. The policy can cover a fixed or flexible period of time.

The actual process for purchasing the insurance is as follows; the property owner contacts the ValueGuard Provider to request a bid for coverage. The Provider requests a variety of pieces of information including mortgage size, income information, employment history, family data and property information. The Provider also researches other information including neighborhood statistics, macroeconomic data, microeconomic data, and property owner's credit history. By analyzing this information, the ValueGuard Provider is able to compute the property owner's premium for the requested coverage. The payment is most likely a monthly payment that is made in conjunction with the mortgage.

If the borrower chooses to purchase the insurance coverage, he provides any additional information and approvals necessary to write a policy. This information can include designating the mortgage company as the beneficiary of the policy, so that the mortgage will be paid prior to the property owner receiving any funds from the insurance.

The insurance then is in place and protects the property owner through the term of the policy. If the property owner does not feel the need to use the insurance, or the policy terminates without use, the Provider keeps the premiums paid by the property owner and the relationship between the ValueGuard Provider and the property owner ceases.

However, if the property's value does not keep pace with the insured value, then the property owner can request that the ValueGuard Provider purchase, or take control of, the house and pay the property owner at the predetermined value as outlined in the policy. The ValueGuard Provider takes control of the property and issues the property owner payment. If the policy includes such a term, the ValueGuard Provider may pay the outstanding mortgage(s) before paying the property owner the remaining funds.

The Provider accepts control of the property and goes through the process of marketing and selling the house at the best possible price. The Provider may charge the property owner against the insured amount a predetermined and agreed upon fee to sell the house to pay for the necessary brokerage, marketing and transaction fees.

The process has four principal components, which the inventor terms: Buying, Underwriting, Activating and Mitigating Risk.

BUYING

To begin the process of purchasing a ValueGuard policy, the buyer does the following:

1. Contacts the ValueGuard Provider and completes the necessary application.

2. Decides on the type and leverage of coverage, including the annual rate of return he wants and the period of coverage.

3. Presents the Provider with a recent appraisal indicating the value of the house.

4. Agrees to the proposed terms and conditions of the insurance.

5. Makes the premium payments required by the Provider in a timely manner.

UNDERWRITING

The Provider takes the following steps to facilitate the underwriting of the insurance policy.

1. Reviews the completed application by property owner.

2. Reviews and approves of the appraisal recently completed on the house.

3. Computes the risk level of the application based on relevant factors.

4. Writes an insurance policy that outlines the level of coverage and describes the specific terms of the agreement including limitation of risk, fees, liabilities etc.

5. Provides, if necessary, information to the lender in order to place a lien on the property.

6. Monitors and accepts the payments by the property owner.

ACTIVATING

If the property owner activates the coverage, the Provider does the following:

1. Receives title or takes control of the property.

2. Issues the property owner payment for the amount due based on the policy.

3. Markets the house for sale either directly or via a real estate brokerage firm.

4. Negotiates the terms and conditions of the sale of the property.

5. Closes on the sale of the house.

6. Uses funds collected by the sale to offset the cost of underwriting that policy.

MITIGATING RISK

The Provider may take a number of actions once the policy is written and issued to mitigate the risk associated with offering this type of insurance, including:

1. Keeps the policies, earning income from the premiums paid.

2. Purchases hedging instruments that counteract the risk of a regional or global recession that could negatively impact the value of the underwritten policies.

3. Bundles and sells some or all of the policies to a larger company or companies.

4. Bundles all or some of the policies together based on the policy and policy holder's profile and sells those policies as a security to investors who by purchasing the policies, earn income from the premiums.

5. Manages these policies even if they are sold to investors.

ADDITIONAL FEATURES

The Provider may permit the following:

The trend rate offered may be either a fixed or variable rate that is tied to a type of inflation based or interest rate index.

The policy may be for a period of no more than a certain number of years or no less than a certain number of years. For example, if a property owner takes a 5 year maximum policy he is covered for up to 5 years. If a property owner purchases a 5 year minimum policy, the property owner would begin coverage 5 years from the purchase of the policy.

The policy may be for an indefinite period of time and only cancelable if the property owner sells the house, dies, or stops making the premium payments.

The policy may require the property owner to care for the property to a certain predetermined level or the policy may be cancelled or reduced in coverage.

The policy may require the property owner to allow annual inspections of the property by a licensed contractor. The contractor's findings may require the property owner to make improvements in the property in order to retain the policy.

The policy may require that an appraisal be completed within a certain period of time around the initial coverage by an approved appraiser.

The policy may require that the premium payment is made to the mortgage company directly as part of the property owner's mortgage payment.

The policy may be automatically cancelable once the mortgage is less than 80% of the home's value.

The policy may also be written for other forms of appreciable assets, including but not limited to apartment buildings, office buildings, commercial buildings, land, art and other collectibles.

The policy may be purchased on behalf of the property owner by other parties including the lender, a homebuilder or another interested party.

The policy may be written to require the property owner to sell the property to the Provider at the predetermined insured price even if the value of the home exceeds the insured value.

The policy may charge the property owner a penalty for such events and actions as early use of the policy, selling the house, allowing the house to fall into disrepair and late premium payments.

The policy may be sold by the Provider to another company or as a security bundled with other policies.

The policy may require the property owner to activate the coverage if he is delinquent or in default on the mortgage.

The policy may allow the property owner to, upon completion of an improvement of the house, amend the policy according to the value of the improvements.

The policy may allow for the Provider to restrict the title of the property so that no other loans can be collateralized by the property.

The policy may allow for the Provider to sell the house on behalf of the owner without the Provider taking ownership of the property.

The policy may allow for the activation of the coverage to occur upon the death of the property owner or it may continue to provide coverage as long as the terms of the policy are met by another resident of the house or associated individual.

The policy may allow for the Provider to share the risk of the policy with the lender, for example, with the Provider only underwriting the top 30% of the policy while the lender underwrites the bottom 70% of the policy.

The policy may allow for the lender to take control of the house instead of the Provider.

### EXAMPLE 1

Michael Bress has just purchased a home in Reston Va. The price of the house is $500,000. Michael has made a down payment of $100,000 and secured a 30-year mortgage. While real estate prices have increased rapidly in the Northern Virginia area over the past 5 years, Michael is concerned the housing market may soften due to a slow down in the local hi-tech economy. While Michael is not required by his lender to purchase Private Mortgage Insurance, he is interested in purchasing a ValueGuard policy to ensure the value of his home. Michael purchases a 10 year, 2.5% annual fixed trend rate policy. This policy states that if Michael sells his home at any point within 10 years of the purchase date, he is guaranteed to receive the purchase price plus a 2.5% annual return. Therefore, Michael is guaranteed that his home will be worth approximately $662,449 in year ten. Michael receives this insurance by making monthly premium payments to his ValueGuard Provider of $98 a month.

After purchasing his ValueGuard policy, Michael makes his payments for four years when he realizes that property values in his neighborhood have continued to appreciate rapidly. He believes the market value of his home is now approximately $625,000. Michael now feels comfortable canceling the policy and assuming the risk of a downturn himself.

### EXAMPLE 2

Miriam Heilizer is currently living with her sister in Madison, Wis. She is very eager to purchase her own house so her dog, Stella, can have a yard of her own. Miriam is a 2^{nd} grade school teacher in the Madison Public School system so he does not earn a great deal of money. She has saved approximately $10,000 for a down payment and has made an offer to purchase a house for $150,000 that is contingent on her securing a financing commitment from a bank. Miriam goes to her local bank and, since she has outstanding credit, is able to receive a commitment from the bank. However, since the mortgage is going to be for an amount equal to 93% of the value of the house, the bank requires Miriam to either purchase Private Mortgage Insurance or a ValueGuard policy that names the bank as the beneficiary of the policy for the amount of the outstanding mortgage. Miriam analyzes these different insurance types and decides to purchase a ValueGuard policy. The lender requires her to purchase at a minimum a 10 year, 1% fixed rate annual return ValueGuard policy. This policy will protect the value of the house Miriam has purchased and guarantee her house value will be approximately $186,617 in year 10. Miriam successfully purchases the home. After 5 years of living in this house, she is ready to move to Baltimore to become a principle at a private academy. She begins to check out the prices of houses locally and realizes that a house across the street from hers with the same layout, just sold for $155,000. The ValueGuard policy she bought guaranteed that her house would be worth $167,853 in year 5. Therefore, Miriam activates the insurance purchase provision of her ValueGuard policy. A ValueGuard representative processes the paperwork and Miriam transfers control of the title of the house to ValueGuard. ValueGuard issues Miriam a payment for $167,853, less the $135,000 outstanding on the mortgage, which is paid directly to the mortgage company, and a 7% ($11,690) fee that ValueGuard charges for selling the house. Therefore, Miriam receives a check for $21,163.

### EXAMPLE 3

Toll Brothers, a major real estate development company, is beginning the marketing of a new 450-house development it is building in the outer suburbs of Denver Colo. Greg Komara, the Head of Marketing for Toll Brothers, knows that a major concern for potential buyers within a new housing development is re-sale value, since the neighborhood has no resale record and the quality of the construction will not be known for several years to come.

To overcome this apprehension, Greg decides to offer the ValueGuard Protection Policy as part of each home sale. Toll Brothers will pay for the first five years of an in perpetuity, 1% annual return ValueGuard policy for each house purchased within this new development. Therefore, Mr. Komara is able to tell the potential purchasers that their homes will increase in value at a rate no less than 1% annually. That means over 30 years that the new home is guaranteed to double in value.

Home sales in the new development go remarkably well and all of the 450 homes are sold within 4 months. Housing values increase at about 4% annually over the next few years due to a strong local economy and the quality of the housing construction. Only 4 of the property owners take advantage of the insurance provision. The remainder of the property owners are able to sell their home at a greater value than the 1% insured rate or let the insurance lapse after the 5 year period because they feel comfortable that their home's value has sufficiently increased to not make it worth paying for a guaranteed 1% annual return.

TECHNICAL IMPLEMENTATION

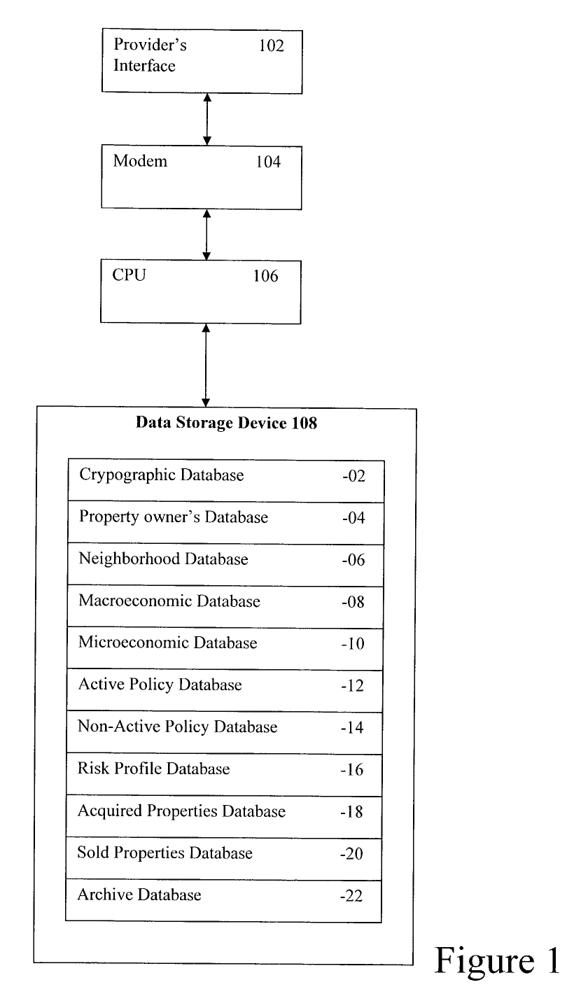

Referring to FIG. 1, a block diagram of the entire system, it is seen that a provider's interface 102, including a conventional modem 104, a conventional CPU 106 accesses via conventional telecommunications link to the Provider's Data Storage Device 108.

Data storage device 108. Includes locations storing cryptographic key data 108-02, Property owner's Database 108-04, Neighborhood Database 108-06, Macroeconomic Database 108-08, Microeconomic Database 108-10, Active Policy Database 108-12, Non-Active Policy Database 108-14, Risk Profile Database 108-16, Acquired Properties Database 108-18, Sold Properties Database 108-20, and Archive Database 108-22.

Data storage device 108 may include conventional hard disk magnetic or optical storage units (such as CD-ROM drives), or flash memory. The particular one of these electronic data storage devices used is a matter of design choice. The amount of storage needed is a function of the volume of business transacted. The principal components of the database (i.e., locations in data storage device 108) are now described.

Cryptographic Database 108-02. This contains the required translation code to interface securely between the Provider's inputs, database, and the server.

Property owner's Database 108-04. This maintains data on the applicant with fields such as name, address, income, and other relevant personal information. This information is received when the property owner completes the application with the Provider.

Neighborhood Database 108-06. This contains information about the neighborhood the property is located within such as census number, crime statistics, demographics and property appreciation history.

Macroeconomic Database 108-08. This contains information on the national and global economy such as Gross Domestic Production, Short and Long Term Interest Rates, Building Permits, Unemployment Rates, Balance of Payments, Consumer Confidence and associated projections.

Microeconomic Database 108-10. This contains data on regional and metropolitan focused data such as local building starts, population movements, unemployment rates.

Active Policy Database 108-12. This tracks information on the active policies that the Provider is currently servicing. This contains information such as number of payments made, inquiries by the property owner, type of policy and changes in credit rating.

Non-Active Policy Database 108-14. This tracks information on the inactive policies that the Provider has previously served. This contains information such as number of payments made, inquiries by the property owner, changes in credit rating, type of policy and details about policy cancellation.

Risk Profile Database 108-16. This contains the formulas required to compute the level of risk and required premium payments for the intended policy. The formulas will access information found in the Macroeconomic, Microeconomic, Neighborhood and Property owner's Databases.

Acquired Properties Database 108-18. This contains information related to the properties that have been turned over to the Provider by the property owner including location, appraised value, marketing efforts and ownership status.

Sold Properties Database 108-20. This contains historical information on all the insured properties that have been sold that had active insurance coverage including information related to the price, length of marketing efforts, neighborhood and property owner's profile.

Archive Database 108-22. This stores all long term data which the Provider tracks on the policy holder's, economy, properties, and other related parties and actions.

Modem 104 may be one or more conventional modems operating at a baud rate of 1200 or upward. At the time of the invention, 128 K is considered a state of the art modem. A T1 or T3 line is appropriate if more bandwidth is required.

PROPERTY OWNER'S PROCESS

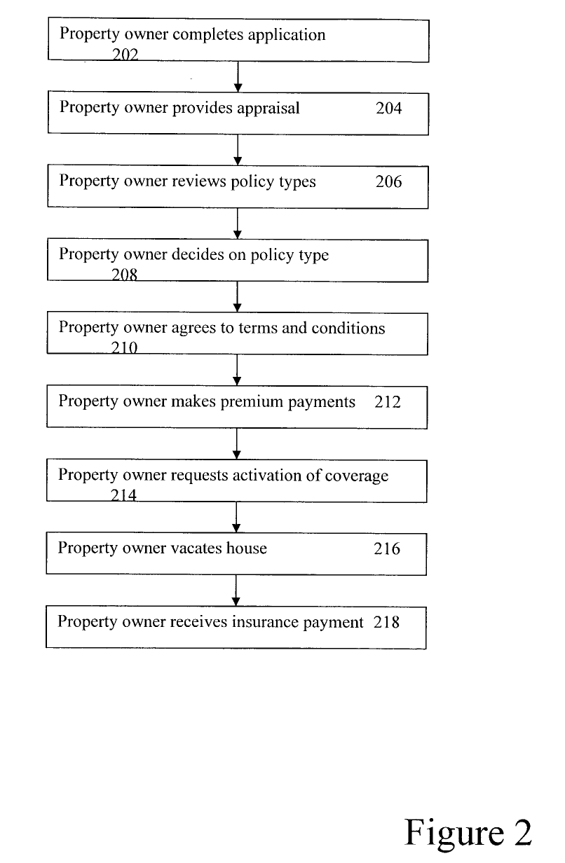

FIG. 2 illustrates how the invention is carried out in a preferred embodiment of the invention, from the standpoint of a property owner's procedure. The order of steps may be varied somewhat arbitrarily, and steps may be added or omitted.

The property owner completes the application either using a paper or computer application. The information requested includes name, contact information, financial history, property information, credit history, and other pertinent information (block 202: Property owner completes information).

The property owner provides the Provider with a recently completed professionally appraisal of the subject property (block 204: Property owner provides appraisal).

Upon approval by the Provider, the property owner reviews the different policy types available and their associated costs. The options include a variety of lengths of coverage, trend rates, early-use penalties and closing cost options. If a policy is purchased as a requirement by a lender, some of the options may be restricted by the lender (block 206: Property owner reviews policy types).

Property owner selects the preferred policy type (block 208: Property owner decides on policy type).

Property owner reviews and agrees to the terms and conditions of the policy. These terms and conditions detail the type of coverage the policy provides, the steps and actions the property owner needs to satisfy in order for the insurance to remain active, and the rights of both the property owner and the Provider (block 210 Property owner agrees to terms and conditions).

The property owner needs to comply with making the premium payments as they are described in the policy. These payments typically occur on a monthly basis and will be mailed to the Provider (block 212: Property owner makes premium payments).

If the property owner wants to activate the coverage, he formally notifies the Provider formally of his desire. This notification currently occurs via certified mail. The request clearly states the property owner's desire to surrender control of the property to the Provider within a certain period of time (block 214: Property owner requests activation of coverage).

Once the activation request has been processed, the property owner needs to vacate the house. The vacancy can occur either once a new buyer has been found or before, depending on the terms outlined in the policy (block 216: Property owner vacates house).

The property owner then receives payment from the Provider based on the terms and conditions laid out in the policy. The payment may already exclude the outstanding mortgage amount and other financial responsibilities of the property owner, such as closing costs (block 218: Property owner receives insurance payment).

The steps of block 212 and block 218 may include as an option using “digital cash”. The practice of using digital cash protocols to effect payment are well known in the art and need not be described here in detail. One of ordinary skill in the art may refer to Daniel C. Lynch and Leslie Lundquist, Digital Money, John Wiley & Sons 1996, or to Seth Godin, Presenting Digital Cash, Sams Net Publishing 1995. If this option is provided the Provider and property owner would transmit payment data appropriate for digital cash purposes. A preferred means for effecting payment to the Provider under this invention may be by some form of electronic commerce transaction, such as digital cash or encrypted credit card transaction.

PROVIDER'S PROCESS

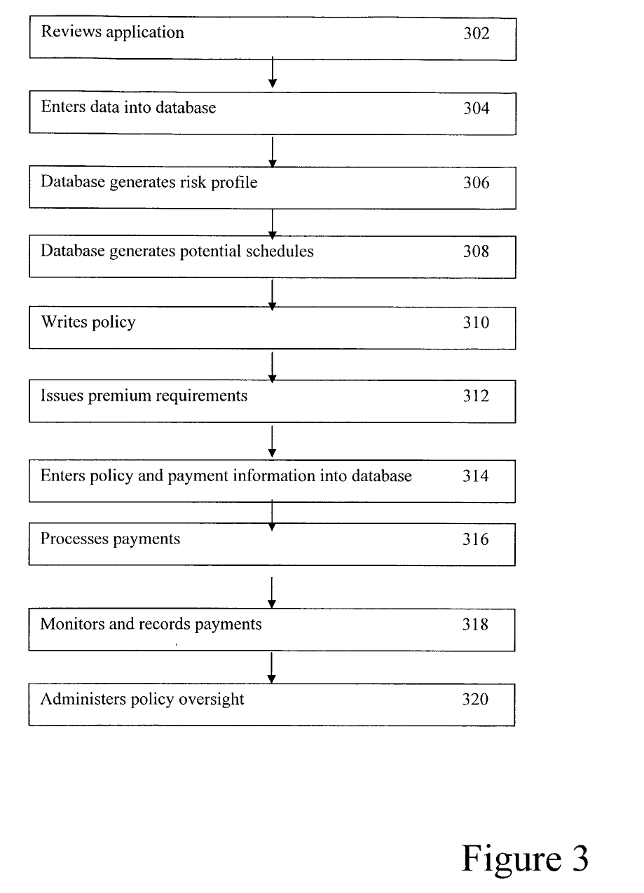

FIG. 3 illustrates how the invention is carried out in a preferred embodiment of the invention, from the standpoint of a Provider. The order of steps may be varied somewhat arbitrarily, and steps may be added or omitted.

In the first step, the Provider reviews the completed application provided by the property owner (block 302: Reviews application). The application information is inputted into the database either directly by the property owner or by the Provider's personnel (block 304: Enters data into database).

Once in the system, the database computes a risk profile for the property owner applicant (block 306: Database generates risk profile).

The database also generates several different premium payment options that contemplate different types of coverage, length of policy and amount of coverage (block 308: Database generates potential schedules).

Upon the property owner applicant's identification and acceptance of a policy, the Provider writes a policy incorporating the selected policy's specific terms (block 310: Writes Policy).

The Provider issues a schedule of payments related to the property owner's policy. This schedule may be in the form of a payment booklet or monthly invoices sent to the property owner (block 312: Issues premium requirements).

The selected policy and payment option is inputted into the database to reflect the selections made by the property owner applicant (block 314: Enters policy and payment information into database).

The Provider accepts and processes the property owner's premium payments and enters this information into the database to reflect the payments made to date (Block 316: Processes Payments).

The Provider monitors and records payments made by the property owner and reviews payments to ensure they are made in a timely manner (block 318: Monitors and records payments).

The Provider administers policy oversight by reviewing the condition of the property, corresponding with the property owner and completing necessary compliance paperwork (block 320: Administer policy oversight).

ACTIVATING COVERAGE

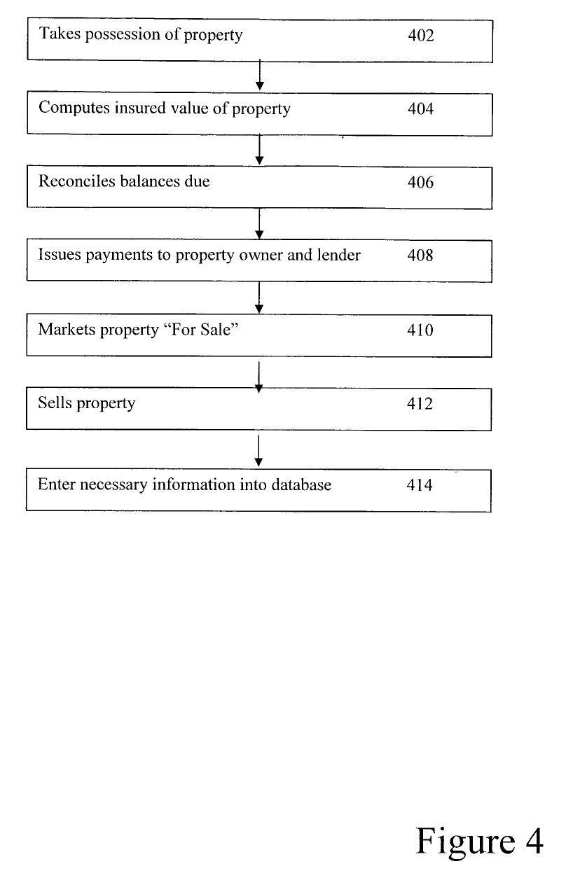

FIG. 4 illustrates the procedure for activating the coverage. The order of steps may be varied somewhat arbitrarily, and steps may be added or omitted.

Once the property owner notifies the Provider that he wants to activate the coverage, the Provider takes control of the property (block 402: Takes possession of property). The Provider then computes the value of the amount due the property owner (block 404: Computes insured value of property) and reconciles this amount with the amount due the lender and any other parties owed funds from the policy (block 406: Reconciles balances due).

The Provider issues payment to satisfy its obligation under the terms of the policy (block 408: Issues payment to property owner and lender).

The Provider then markets the property for sale either directly or via a licensed brokerage firm (block 410: Markets property “For Sale”).

The Provider reviews, accepts, and completes an offer to sell the property (block 412: Sells property).

The Provider enters in the necessary information so that the database accurately reflects the status and results of the policy (block 414: Enters necessary information into database).

PROVIDER'S DATABASE PROCESS

The Provider's database accepts, stores and computes the applicant data once it is inputted by the Provider or property owner (block 502: Database accepts, stores and computes necessary applicant data).

Once the information is entered, the database will compute a risk profile for that applicant. The risk profile composition uses actuarially-sound underwriting assumptions and formulas based on the information stored in the database to compute a risk profile or score for this applicant and their property (block 504: Database generates risk profile).

Once a risk score is computed, the database classifies the applicant within a risk range. The risk range is associated with premium levels for the different policy types (block 506: Database classifies policy within specifics risk category).

Once the policy type is selected and agreed to by the property owner applicant, the policy is matched with other similar policies based both of policy type and the property owner's risk profile (block 508: Policy is grouped with other similar policies).

The database generates the expected financial return from each group of policies based on historical data, applicant profile and policy type (block 510: Group policies expected performance and profile is generated by database).

The database is continually updated to reflect the current status of the policies (block 512: Policies status are recorded and updated).

MANUAL OPERATIONS

Although it is a less preferred embodiment, the invention can be practiced without a database in whole or in substantial part. Thus, a prospective Provider can manually track, record and compute the necessary policy and risk data.

ARTICLE OF MANUFACTURE ASPECTS OF INVENTION

While the inventor plans to practice the invention in the United States, it is apparent that it would be possible for an operation to be established outside the United States for the purpose of soliciting business over the Internet from property owners located in the United States. In this event, the effect would be that an operation outside the United States could practice the substance of the invention and arguably maintain that no direct infringement occurred within the United States.

However, practicing the invention by soliciting business over the Internet located in the United States does involve the making of certain articles of manufacture in the United States and their importation thereinto. First, doing Internet business with in the United States inevitably involves encoding information onto information media of servers of Internet Service Providers (ISPs) in the United States, for example, hard disk drives maintained by the ISPs. This activity constitutes the making of an encoded medium or of a data structure or the use thereof, as well as the active inducement of such acts. In addition, doing Internet business in the United States inevitably involves making and using a propagated signal that is transmitted over the Internet, as well as the active inducement of such conduct. Activity of the foregoing kind has been recognized in the PTO as the making or using of an article of manufacture. See generally Nancy J. Linck and Karen A. Buchanan, Patent Protection for Computer-Related Inventions: The Past, the Present, and the Future, 18 HASTINGS COMM. & ENT. L. J. 659, 677B78 (1996)(stating that PTO views such acts as the result of human agency rather than natural forces, and therefore patentable subject matter under current PTO guidelines for patentability).

Accordingly, the inventor considers that his invention extends to articles of manufacture comprising encoded media that are used in practicing his invention, and also such signals. Thus, an Internet server within the United States may be caused to have its hard disk array, optical drive, or other information medium encoded with such machine-readable information as application information. In that circumstance, an article of manufacture is made and caused to be made that contains the aforesaid encoded machine-readable information. By the same token, these actions involve the making of a propagated signal in the United States containing corresponding encoded information. The signal is transmitted over a telecommunications link used to enable operation of the Internet, which the Operator utilizes to carry out the invention.

CONCLUDING REMARKS

While the invention has been described in connection with specific and preferred embodiments thereof, it is capable of further modifications without departing from the spirit and scope of the invention. This application is intended to cover all variations, uses, or adaptations of the invention, following, in general, the principles of the invention and including such departures from the present disclosure as come within known or customary practice within the art to which the invention pertains, or as are obvious to persons skilled in the art, at the time the departure is made. It should be appreciated that the scope of this invention is not limited to the detailed description of the invention hereinabove, which is intended merely to be illustrative, but rather comprehends the subject matter defined by the following claims.

As used in the following claims, the term “Property owner Applicant” means the person going through the process of applying for, reviewing and accepting a policy.

The term “Internet” includes closed proprietary data systems (dial-up networks) such as AOL.

The term “Provider” means the company, organization or person offering the described ValueGuard insurance product.

The term “Trend Rate” means the rate at which the policy's value increases annually. Therefore, if the trend rate is 3%, then the house is guaranteed to appreciate at a 3% annual rate of growth.

The term “Activation of Coverage” means the point at which the insurance company takes control of the property and begins the liquidation and payment process.

I claim the following:

1. A method of providing insurance coverage to a policyholder, by an insurance provider, whereby the insurance policy insures the future value of real estate property said method comprising the steps of:
(1) compiling by said insurance provider information about said real estate property and said policyholder's profile;
(2) storing said information in a computer-readable form in an electronic data storage device;
(3) computing by said insurance provider a premium payment amount that corresponds with the risk of said insurance coverage;
(4) selecting by said prospective policyholder the desired terms of said insurance coverage;
(5) acknowledging by both said policyholder and said insurance provider that said policy commits said insurance provider to make payment, if said insurance coverage is activated, in the amount of said future value;
(6) paying by said policyholder, whether directly or indirectly, of a premium payment to said insurance provider for said insurance coverage;
(7) providing financial payment by said insurance provider if said insurance coverage is activated.

2. The method of claim 1 wherein said insurance coverage is purchased on behalf of said policyholder by another party.

3. The method of claim 1 wherein the projection of said future value of said insurance coverage is based on a fixed appreciation rate.

4. The method of claim 1 wherein the projection of said future value of said insurance coverage is based on a variable appreciation rate.

5. The method of claim 1 wherein said step (3) is preceded by insurance provider completing an appraisal of said real estate property to discover current value of said real estate property.

6. The method of claim 1 wherein said insurance provider places a lien or restriction on the title of said real estate property to limit the ability of said policyholder to receive another lien on said real estate property.

7. The method of claim 1 wherein ownership of said real estate property is transferred from said policyholder to said insurance provider once said insurance coverage is activated.

8. The method of claim 7 wherein said insurance provider sells said real estate property upon activation of said insurance coverage.

9. The method of claim 1 wherein control of said real estate property is transferred from said policyholder to said insurance provider once said insurance coverage is activated.

10. The method of claim 9 wherein said insurance provider sells said real estate property upon activation of said insurance coverage on behalf of said policyholder.

11. The method of claim 1 wherein said insurance provider inspects said real estate property prior to activation of said insurance coverage.

12. The method of claim 11 wherein said insurance provider deducts from said insured coverage the amount of damage or deferred maintenance costs found during said inspection.

13. The method of claim 1 wherein mortgage lien holder is paid from the proceeds of said policy prior to the payment to said policyholder.

14. The method of claim 1 wherein said policyholder can cancel said insurance coverage.

15. The method of claim 1 wherein said insurance policy must be active for a certain period of time prior to said insurance coverage being available to said policyholder.

16. The method of claim 1 wherein said insurance coverage is active for a finite period of time.

17. The method of claim 1 wherein said insurance coverage is active for an indefinite period of time as long as said policyholder makes required said premium payments.

18. The method of claim 1 wherein said insurance provider makes periodic inspections of said real estate property to ensure continued maintenance of said real estate property.

19. The method of claim 1 wherein said policyholder makes said premium payment directly to the mortgage lien holder.

20. The method of claim 1 wherein said insurance policy is automatically cancelled once a predetermined amount of said real estate property's mortgage is paid.

21. The method of claim 1 wherein said policyholder automatically activates said insurance coverage if said policyholder is delinquent in making mortgage payments.

22. The method of claim 1 wherein said insurance provider is permitted by said policyholder to sell said real estate property on said policyholder's behalf without needing to be the owner of said real estate property.

23. The method of claim 1 wherein said insurance coverage is automatically activated upon the death of said policyholder.

24. A method of claim 1 wherein said insurance coverage is automatically activated upon a delinquent said premium payment.

25. A method of claim 1 whereby said insurance provider only provides for said insurance coverage up to a certain predetermined limit.

26. A method of claim 1 whereby said policyholder may be required to sell the property at a future point in time to the said insurance company at a certain predetermined price.

27. A system for applying for property value insurance, said system comprising:
a computer system comprising a control unit and a data storage unit;
coupled to said computer system via a telecommunications link, means for providing necessary information about the potential policy holder and property:
coupled to said computer system, means for creating in said data storage unit a record of said application;
coupled to said computer system, means for calculating the perceived risk and required premium to pay for said risk;
coupled to said computer system a means for tracking the payment of said premium payments.

28. An article of manufacture comprising
an information storage medium encoded with a computer—readable data structure for use in connection with managing a property value insurance product; or
a propagated signal for use in said connection.

29. An article of manufacture according to claim 28 wherein said data structure comprises at least one data field with information identifying a policy holder and information about the property being insured.

30. An article of manufacture according to claim 28 wherein said data structure comprises at least one data field with information identifying the length and type of said policy.

31. An article of manufacture according to claim 28 wherein said data structure comprises at least one data field with information identifying the status of said premium payments.
